(19) United States
(12) Patent Application Publication
(10) Pub. No.: US 2006/0045374 A1
(43) Pub. Date: Mar. 2, 2006

(54) Method and apparatus for processing document image captured by camera

(75) Inventors: Yu Nam Kim, Seoul (KR); Sang Wook Park, Gimpo-si (KR); Sung Hyun Kim, Yongin-si (KR); Seong Chan Byun, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/216,585

(22) Filed: Aug. 30, 2005

(30) Foreign Application Priority Data
Aug. 31, 2004 (KR) 10-2004-0069320
Sep. 2, 2004 (KR) 10-2004-0069843

(51) Int. Cl. G06K 9/40

(52) U.S. Cl. 382/255

(57) ABSTRACT

A document image processing apparatus includes an image capturing unit for capturing an image of a document, a detecting unit for detecting focusing and twisting states of the capture image, a display unit for displaying the detected focusing and twisting states, a character recognition unit for recognizing characters written on the capture image, and a storing unit for storing the recognized characters by fields.

### CROSS REFERENCE TO RELATED APPLICATIONS

Pursuant to 35 U.S.C. § 119(a), this application claims the benefit of earlier filing date and right of priority to Korean Patent Application Nos. 10-2004-0069320 and 10-2004-0069843, filed on Aug. 31, 2004 and Sep. 2, 2004, respectively, the contents of which are hereby incorporated by reference herein in their entirety.

### BACKGROUND OF THE INVENTION

1. Field of the Invention

The present invention relates to a method and apparatus for recognizing characters on a document image captured by a camera and saving recognized characters. Particularly, the present invention relates to a method and apparatus for recognizing characters on a name card image captured by a mobile camera phone with an internalized or externalized camera and automatically saving the recognized characters in corresponding fields of a predetermined form such as a telephone directory database.

2. Description of the Related Art

An optical character recognition (OCR) system or a scanner-based character recognition system has been widely used to recognize characters on a document image. However, since these systems are dedicated system for recognizing characters on a document image, massive applications and hardware sources are required to process and recognize the document image. Therefore, it is difficult to simply apply the character recognition method used in the OCR system or scanner based recognition system to a device having a limited process and memory. A mobile camera phone may be designed to recognize the characters. That is, the camera phone is used to take a picture of a small name card, recognize the characters on the captured image, and automatically save the recognized characters in a phone number database. However, since the mobile camera phone has a limited processor and memory, it is difficult to accurately process the image and recognize the characters on the image.

Describing a method for recognizing a name card using the mobile camera phone in more detail, a name card image is first captured by a camera of the mobile camera phone and the characters on the captured card image are recognized by fields using a character recognition algorithm. The recognized characters are displayed by fields such as a name, a telephone number, an e-mail address, and the like. Then, the characters displayed by fields are corrected and edited. The corrected and edited characters are saved in a predetermined form of a phone number database.

However, when the focus of the name card image is not accurately adjusted or the name card image is not correctly position, the recognition rate is lowered. Particularly, when the camera is not provided with an automatic focusing function, twisted, the focus adjustment and the correct disposition of the name card image must be determined by eyes of the user. This makes it difficult to take the clear name card image that can allow for the correct recognition.

Generally, when a user receives name cards from customers, friends and the like, the users opens a phone number editor of his/her mobile phone and inputs the information on the name card by himself/herself using a keypad of the mobile phone. This is troublesome for the user. Therefore, a mobile camera phone having a character recognizing function has been developed to take a picture of the name card and automatically save the information on the name card in the phone number database. That is, a document/name card image is captured by an internalized or externalized camera of a mobile camera phone and characters on the captured image are recognized according to a character recognition algorithm. The recognized characters are automatically saved in the phone number database.

However, when a relatively large number of characters are existed on image capture by the camera or scanner, since the mobile phone has a limited process and memory source, a relatively long process time is taken even when the recognition process is optimized. Furthermore, when the characters are composed in a variety of languages, the recognition rate may be deteriorated as compared with when they are composed in a single language.

FIG. 1 shows a schematic block diagram of a prior mobile phone with a character recognizing function.

A mobile phone includes a control unit 5, a keypad 1, a display unit 3, a memory unit 9, an audio converting unit 7c, a camera module unit 7b, and a radio circuit unit 7a.

The control unit 5 processes data of a document (name card) image read by the camera module unit 7b, output the processed data to the display unit 3, processes editing commands of the displayed data, which are inputted by a user, and save the data edited by the user in the memory unit 9. The keypad 1 functions as a user interface for selecting and manipulating the function of the mobile phone. The display unit 3 displays a variety of menu screens, a run screen and a result screen. The display unit 3 further displays an interface screen such as a document image data screen, a data editing screen and an edited data storage screen so that the user edits the data and save the edited data. The memory unit 9 is generally comprised of a flash memory, a random access memory, a read only memory. The memory unit 9 saves a real time operating system and software for processing the mobile phone, and information on parameters and states of the software and the operating system and performs the data input/output in accordance with commands of the control unit 5. Particularly, the memory unit 9 saves a phone number database in which the information corresponding to the recognized characters through a mapping process.

The audio converting unit 7c processes voice signal inputted through a microphone by a user and transmits the processed signal to the control unit 5 or outputs the processed signal through a speaker. The camera module unit 7b processes the data of the name card image captured by the camera and transmits the processed data to the control unit 5. The camera may be internalized or externalized in or from the mobile phone. The camera is a digital camera. The radio circuit unit 7a functions to connect to mobile communication network and process the transmission/receive of the signal.

FIG. 2 shows a block diagram of a prior name card recognition engine.

A prior name card recognition engine includes a still image capture block 11, a character-line recognition block 12, and application software 13 for a name card recognition editor.

The still image capture block 11 converts the image captured by a digital camera 10 into a still image. The character line recognition block 12 recognizes the characters on the still image, converts the recognized characters into a character line, and transmits the character line to the application software. The application software 13 performs the name card recognition according to a flowchart depicted in FIG. 3.

A photographing menu is first selected using a keypad 1 (S31) and the name card image photographed by the camera is displayed on the display unit (S32). A name card recognition menu for reading the name card is selected S33. Since the recognized data is not accurate in an initial step, the data cannot be directed transmitted to the database (a personal information managing data base such as a phone number database) saved in the memory unit. Therefore, the name card recognition engine recognizes the name card, coverts the same into the character line, and transmits the character line to the application software. The application software supports the mapping function so that the character line matches with an input form saved in the database.

The recognized name card data and the editing screen is displayed on the display unit so that the user can edits the name card data and performs the mapping process (S34 and S35). The user corrects or deletes the characters when there is an error in the character line. Then, the user selects a character line that he/she wishes to save and saves the selected character line. That is, when the mapping process is completed, the user selects a menu “save in a personal information box” to save the recognized character information of the photographed name card image in the memory unit (S36).

FIGS. 4 and 5 show an example of a name card recognition process.

FIG. 4 is an editing screen by which the user can corrects or deletes the wrong characters when the user finds the wrong characters while watching the screens provided in the steps S34 and S35. In the editing screen, the user moves a cursor to a wrong characters “DEL” 40 to change the same to a correct characters “TEL”. After the editing is finished, the user selects only character lines that he/she wishes to save in the database and saves the same in the memory unit. For example, as shown in FIG. 5, when a job title of the name card is “Master Researcher,” the line “Master Researcher” 50 is blocked and a field “title” 61 is selected in a menu list 60. Then, the mapping process is performed to save the “Master Researcher” that is a recognition result in a title field of the database.

In order to improve the recognition rate of the mobile phone, a clear, correct document image data (a photographed name card image data) must be provided to an input device of the character recognition system.

The clear document image closely relates to a focus. The focus highly affects on the separation of the characters from the background and on the recognition of the separated characters. The twist of the image also affects on the accurate character recognition as the characters are also twisted when the overall image is twisted. Although a high performance camera or a camcorder has an automatic focusing function, when a camera without the automatic focusing function is associated with a mobile phone, the focusing and twist states of the image captured by the camera must be identified by naked eyes of the user. This causes the character recognition rate to be lowered.

### SUMMARY OF THE INVENTION

Accordingly, the present invention is directed to a document image processing method and apparatus, which substantially obviate one or more problems due to limitations and disadvantages of the related art.

It is an object of the present invention to provide a method and apparatus for processing a document image, that can detects a focusing and/or twist states of the document image captured by a camera and provide the detected results to a user through a pre-view screen, thereby allowing a clear, correct document image to be obtained.

It is another object of the present invention to provide a method and apparatus for processing a document image, which can obtain a clear, correct document image by displaying a focusing and twist state of the document image captured by a camera through a pre-view screen before the characters of the document image is recognized.

It is still another object of the present invention to provide a method and apparatus for processing a document image, which can obtain a clear, correct document image even using a mobile phone camera that has no automatic focusing function.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly selected out in the written description and claims hereof as well as the appended drawings.

To achieve these objects and other advantages and in accordance with the purpose of the invention, as embodied and broadly described herein, there is provided a document image processing apparatus, comprising: an image capturing unit for capturing an image of a document; a detecting unit for detecting focusing and twisting states of the capture image; a display unit for displaying the detected focusing and twisting states; a character recognition unit for recognizing characters written on the capture image; and a storing unit for storing the recognized characters by fields.

The focusing and twisting states are displayed on a pre-view screen so as to let a user adjust the focusing and twist of the image.

According to another aspect of the present invention, there is provided a mobile phone with a name card recognition function, comprising: a detecting unit for detecting focusing and twisting states of a name card image captured by a camera; a display unit for displaying the focusing and twisting states of the name card image; a character recognition unit for recognizing characters written on the name card image; and a storing unit for storing the recognized characters in a personal information-managing database by fields.

The focusing and twisting states of the name card is detected by extracting an interesting area from the name card image, calculating a twisting level from a bright component obtained from the interesting area, and calculating a focusing level by extracting a high frequency component from the bright component.

According to another aspect of the present invention, there is provided a document image processing method of a mobile phone, comprising: capturing an image of a document using a camera; detecting focusing and/or twisting states of the captured image; displaying the detected focusing and twisting states; and guiding a user to finally capture the document image based on the displayed focusing and/or twist states.

According to still another aspect of the present invention, there is provided a name card image processing method of a mobile phone, comprising: capturing a name card image; detecting focusing and/or twisting states of the captured name card image; displaying the detected focusing and twisting states; guiding a user to finally capture the document image based on the displayed focusing and/or twist states; recognizing characters written on the captured image; and storing the recognized characters by fields.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic block diagram of a prior mobile phone with a character recognizing function.

FIG. 2 is a schematic block diagram of a prior name card recognition engine;

FIG. 3 is a flowchart illustrating a prior name card recognition process;

FIGS. 4 and 5 are views of an example of a name card recognition process depicted in FIG. 3;

FIG. 6 is a block diagram of a name card recognition apparatus of a mobile phone according to an embodiment of the present invention;

FIG. 7 is a flowchart illustrating a name card recognition process according to an embodiment of the present invention;

FIG. 8 is a view illustrating a name card recognition process of a photographing support unit;

FIG. 9 is a view illustrating a name card recognition process of a recognition field selecting unit;

FIG. 10 is a view illustrating a name card recognition process of a recognition result editing unit;

FIG. 11 is a block diagram illustrating an image capturing unit and an image processing unit of a mobile phone according to an embodiment of the present invention;

FIG. 12 is a flowchart illustrating a display process of an image captured by a camera according to an embodiment of the present invention;

FIG. 13 is a flowchart illustrating a process for extracting an interesting area after recognizing an image according to an embodiment of the present invention;

FIG. 14 is a flowchart illustrating an image detecting process of a focus detecting unit according to an embodiment of the present invention;

FIG. 15 is a flowchart illustrating a focusing level detecting process of a focus detecting unit according to an embodiment of the present invention; and

FIG. 16 is a flowchart illustrating a twist detecting process of a twist detecting unit according to an embodiment of the present invention.

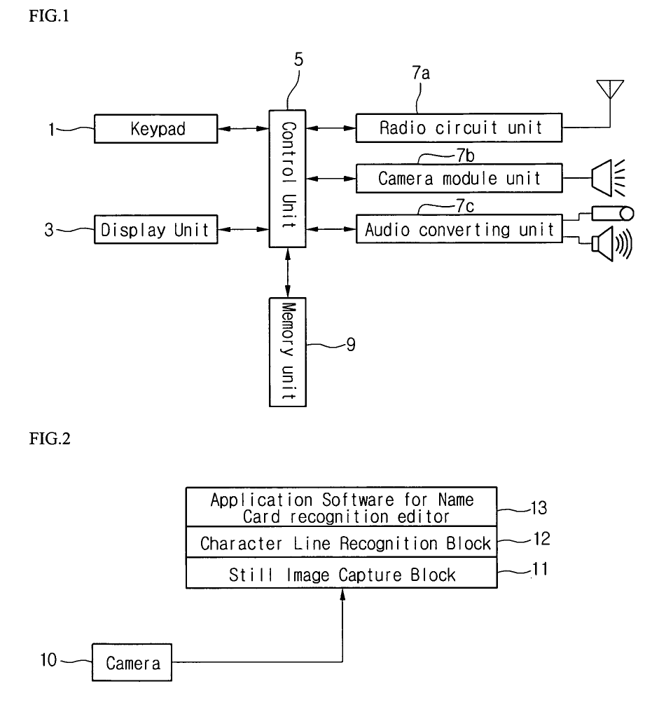

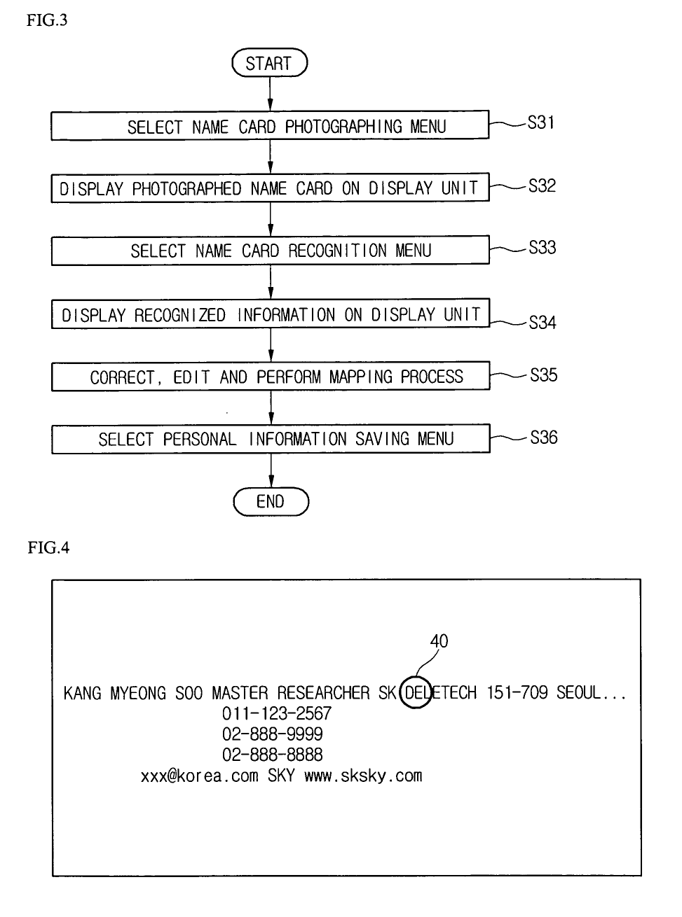

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

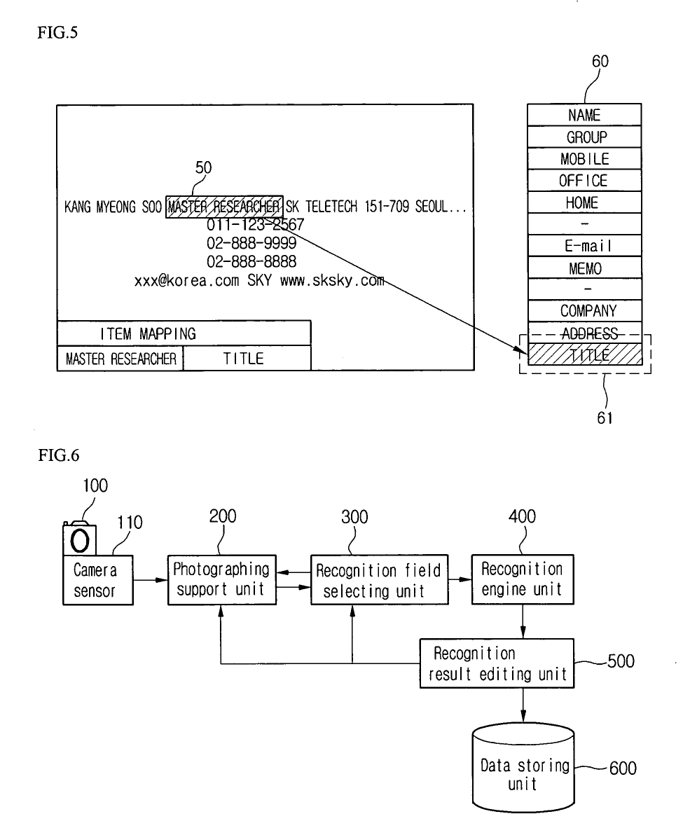

FIG. 6 shows a block diagram of a name card recognition apparatus of a mobile phone according to an embodiment of the present invention.

As shown in FIG. 6, a name card recognition apparatus integrated in a mobile phone includes a camera 100 and camera sensor 110 for taking a picture of a name card image, a photographing support unit 200 for determining focusing and leveling states of an image captured by the camera and camera sensor 100 and 110, a recognition field selecting unit 300 for selecting fields, which will be recognized, from the name card image captured by the photographing support unit 200, a recognition engine unit 400 performing a recognition process for the name card image when the focusing and leveling states of the name card image are adjusted by the photographing support unit 200, a recognition result editing unit 500 for editing recognized characters, symbols, figures and the like on the recognized name card image, and a data storing unit 600 for storing the image information including the characters, symbols, figures, and the like that are edited by the recognition result editing unit 500.

The operation of the name card recognition apparatus will be described hereinafter.

The name card image captured by the camera and camera sensor 100 and 110 is pre-processed by the photographing support unit 200. The photographing support unit 200 displays the focusing and leveling states of the name card image through a pre-view screen so that the user identifies if the name card image is clear or not. The higher the focusing and leveling, the higher the recognition rate of the image. Therefore, it is important to adjust the focusing of the image when the image is photographed. In the present invention, the photographing support unit displays the focusing and leveling states of the name card image to let the user know if the camera 100 is in a state where it can accurately recognize the characters on the name card image.

Generally, it is considered that the user takes a picture of the image within a twist angle range of −20-+20 degrees when it is assumed that the image is not turned down. In this case, by letting the user know the twist of the image through the pre-view screen, it becomes possible to adjust the image to the twist angle close to 0-degree. This will be described in more detail later.

The recognition field selection unit 300 allows the user to select the fields from the clear image. Therefore, the recognition process is performed only for the selected fields. In addition, the recognition engine unit 400 performs the recognition process only for the fields selected by the user. The fields recognized in the recognition engine unit 400 are stored in corresponding selected fields such as a name field, a telephone number field, a facsimile number field, a mobile phone number field, an e-mail address field, a company name field, a title field, an address field, and the like by the recognition result editing unit 500. Among the fields, only the six major fields such as the name field, the telephone number field, the facsimile number field, the mobile phone number field, the e-mail address field, and the memo field are displayed. The rest fields are displayed in an additional memo field.

The recognition result editing unit 500 stores the recognition results in the data storing unit 600 as a database format and allows for the data search, data edit, SMS data transmission, phone call, group designation. The recognition result editing unit 500 determines if an additional photographing of the name card is required. When the additional photographing is performed, the current image data is stored in a temporary buffer.

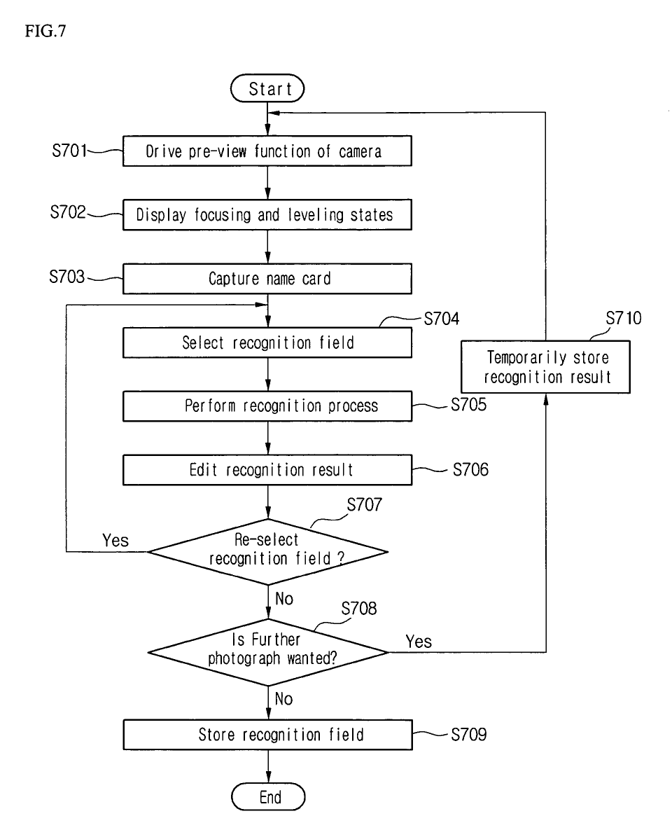

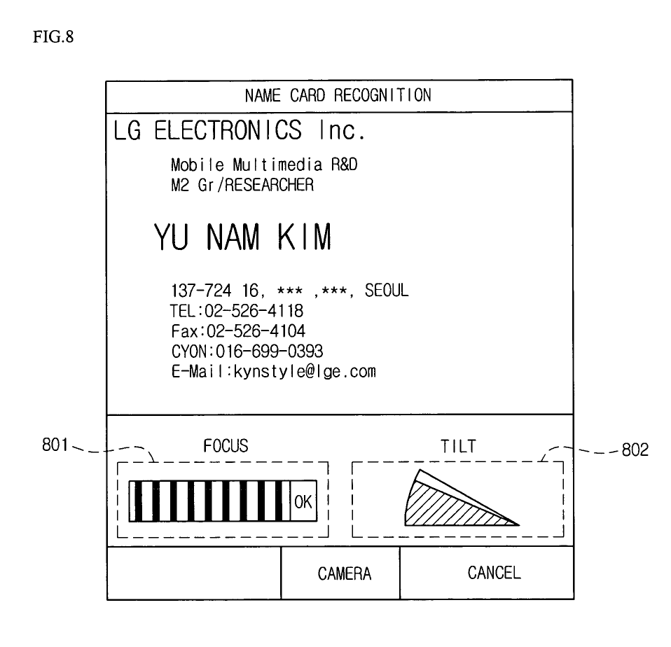

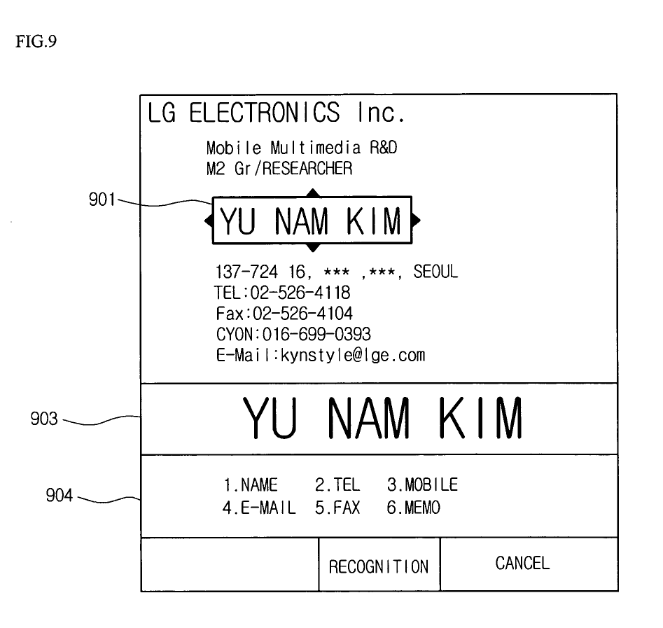

FIG. 7 shows a flowchart illustrating a name card recognition process according to an embodiment of the present invention.

As shown in FIG. 7, the name card image captured by the camera and the camera sensor is displayed according to a pre-view function of the camera (S701). The focusing and leveling states of the name card image is displayed on the pre-view screen so that the user can identify the characters, symbols, figures and the like written on the name card are clearly captured (S702). When the focusing and leveling of the name card image is accurately adjusted according to the pre-view function of the camera, the name card image is accurately captured on the basis of the focusing and leveling states displayed on the pre-view screen (S703). The user selects field, for which he/she wishes to recognize, from the captured name card image through the recognition field selection unit. Then, the recognition process is performed for the selected fields by the recognition engine unit (S704). When the recognition process is performed, the recognized fields are edited by the recognition result editing unit (S706). After it is determined if there is any error on the recognition fields or if there is a case where an additional recognition is required, when it is determined that it is required to additionally select additional fields, the additional fields are additionally selected and the recognition process for the additional fields is performed (S707 and S704). When it is determined that there is no need to additionally select the additional field, it is determined if there is a need to further photograph the name card. When it is determined that there is a need to further photograph the name card, the current recognition results are stored in the temporary buffer (S710) and the user retakes the picture of the name card (S708 and S701). The retake of the name card is generally required when the fields necessary for the user are existed on both surfaces of the name card. That is, after taking the front surface image of the name card and the selected fields on the front surface is recognized and stored in the temporary buffer, the user takes the rear surface image of the name card and the selected fields on the rear surface is recognized and stored. When it is determined that there is no need to additionally retake the name card, the recognized fields are stored in the data storing unit (S709).

FIG. 8 illustrates a name card recognition process of a photographing support unit.

As shown in FIG. 8, the focusing and leveling states of the name card image captured by the camera and the camera sensor are displayed in real time according to the camera pre-view function of the photographing support unit. That is, the focusing and leveling states are displayed by focusing and leveling state display units 801 and 802 through the pre-view screen so that the user can take a clear, correct name card image while observing the pre-view screen. The focusing and leveling states of the name card image may be displayed in a numerical value or in a graphic image displaying a level. That is, when the focusing state display unit 801 displays “OK,” it means that the focusing is adjusted to a state where the characters written on the name card image can be accurately recognized. At this same time, the leveling state display unit 802 lets the user determine if the name card image is leveled to a state where the characters written on the name card image can be accurately recognized. That is, since the leveling display unit 802 displays the leveling state of the name card image in real time, the user can take a picture of the name card image while adjusting the leveling of the name card image. That is, before performing the recognition process, since it can be determined if the name card is photographed to a state where the characters, symbols and figures can be accurately recognized, the error can be minimized in the following recognition process.

FIG. 9 illustrates a name card recognition process of a recognition field selecting unit.

As shown in FIG. 9, the user selects desired fields from the name card image that is clearly photographed through the photographing support unit. The recognition engine performs the recognition process only for the selected fields, thereby improving the recognition efficiency. The fields are selected by lines or selected by sections in each line according to a distance between the characters. In FIG. 9, a cursor 901 points a field and an enlarged window 903 displays the pointed field. When the cursor 901 points a name “Yu Nam KIM” and the user selects the number “1” corresponding to the “name” displayed on a selection section 904, the pointed name “Yu Nam KIM” is mapped on the name field. As described above, the pre-selection is performed for the desired field, the character recognition is performed by the recognition engine.

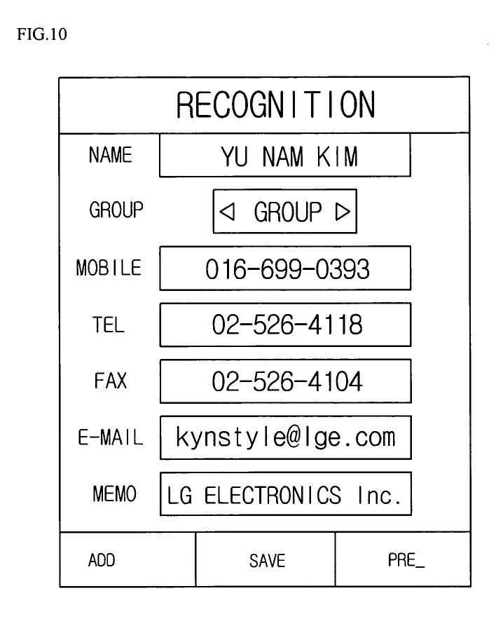

FIG. 10 illustrates a name card recognition process of a recognition result editing unit.

The fields are selected by the user and the recognition results for the selected fields are illustrated in FIG. 10. That is, the name, mobile phone number, telephone number, facsimile number, email address, and title are recognized. As described above, the character recognition process is performed only for the fields selected by the user and the recognition result editing unit stores the recognized image data or determines if there is a need to additionally take a photograph or to reselect additional fields on the image.

FIG. 11 shows a block diagram illustrating an image capturing unit and an image processing unit of a mobile phone according to an embodiment of the present invention.

As shown in FIG. 11, in order to take a photograph and recognize characters (including symbols, figures, human faces, shapes of objects) of the photograph, the mobile phone includes an image capturing unit 100 having a camera lens 101, a sensor 103, and a camera control unit 104 for an A/D conversion and a color space conversion of the photographed image, an image processing unit 200 having a plurality of sensors for detecting the focusing and/or twist states of the image captured from the image capturing unit 100, and a display unit 300 for displaying the image processed by the image processing unit 200.

A sensor 103 formed of a charge coupled device or a complementary metal oxide semiconductor may be provided between the image capturing unit 100 and the camera lens 101.

Using the camera lens 101, the sensor 103 and the camera control unit 104 of the image capturing unit 100, the characters written on the name card is photographed. At this point, the detecting unit 200 of the image processing unit 200 detects if the focusing and leveling states of the photographed image is in a state where the characters written on the name card can be accurately recognized.

When it is determined that the focusing is not accurately adjusted, the location of the mobile phone is changed until a signal indicating the accurate focusing adjustment is generated. Likewise, the leveling is also adjusted in the above-described method.

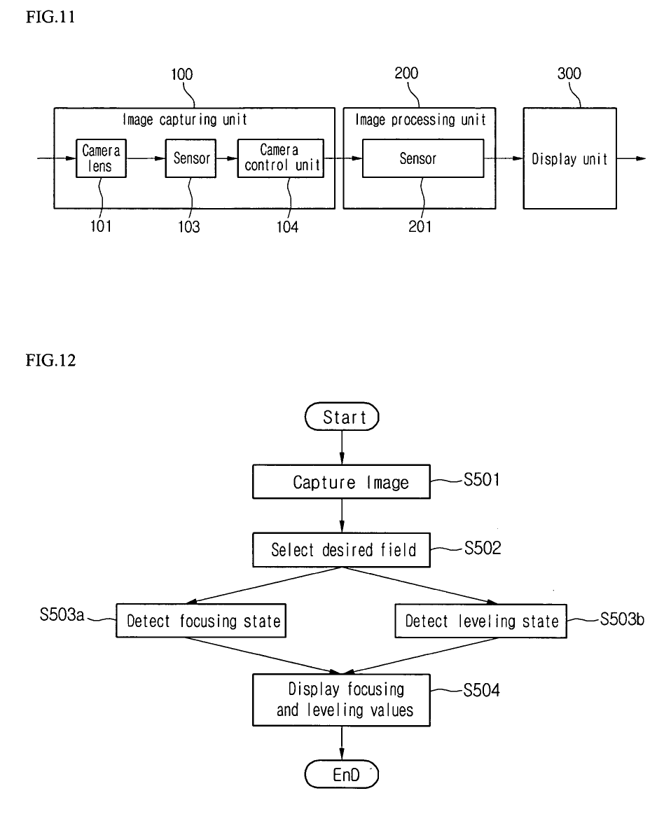

FIG. 12 illustrates a display process of an image captured by a camera according to an embodiment of the present invention.

As shown in FIG. 12, the name card image is captured by the image capturing unit having camera lens, sensor and camera controller (S501). The desired fields are selected from the captured image (S502). The detecting unit detects the focusing and leveling state of the desired fields (S503a and S503b).

A bright signal of the captured name card image may be used to detect the focusing and/or leveling states of the desired fields. That is, the detecting unit receives only bright components of the image inputted from the image capturing unit. A size of the image inputted from the image capturing unit is less than QVGA(320×240). More generally, the size is QCIF(176×144) to process all frames of 15 fps image in rear time, thereby displaying the focusing and leveling values on the display unit (S504).

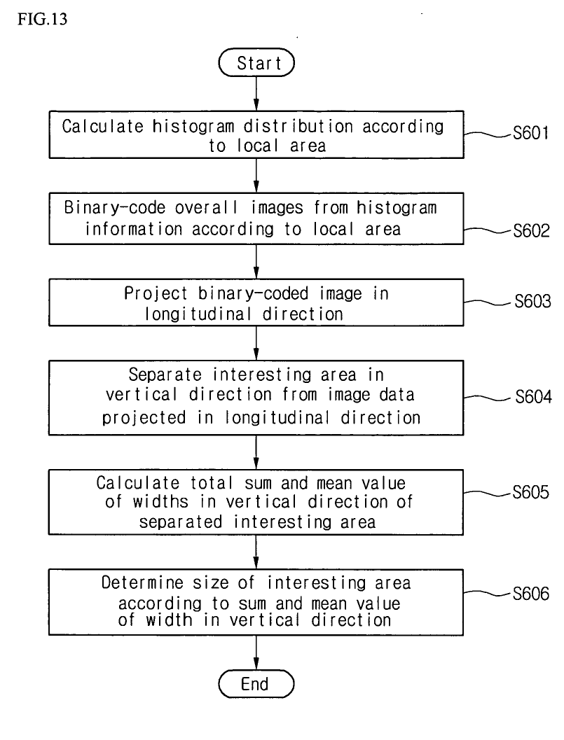

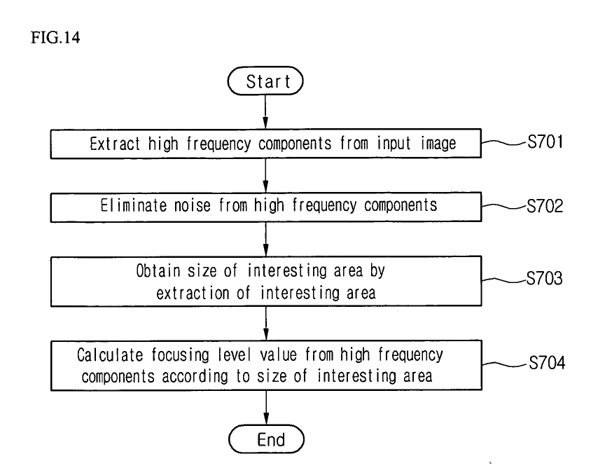

FIG. 13 illustrates a process for extracting an interesting area after recognizing an image according to an embodiment of the present invention.

As shown in FIG. 13, a histogram distribution is calculated from the bright components of the image signal captured by the image capturing unit according to local areas (S601). The size of each local area is 1(pixel)×10(pixel). The local area histogram_Y at a location (I,j) can be expressed by the following equation 1.

That is, the size can be the 10(pixel)×1(pixel) and the brightness can be adjusted to reduce the amount of calculation of the histogram. In the present invention, the description is done based on 8 steps.
Histogram_Y[I,j+k]/32] (Equation 1)

The Y(I,j) is a bright value long the location (I,j) and the k has values from 0 to 9. In addition, the i indicates a longitudinal coordinate and the j indicates a vertical coordinate.

The overall image is binary-coded from the histogram information calculated according to the local area (S602). In this binary-coding process, a difference between a maximum value (max{Histogram_Y[k]})of 10-Histogram_Y[k] and a minimum value (min{Histogram_Y[k]}) is calculated. When the difference is greater than a critical value T1, the local area is regarded as an interesting area. A value “1” is inputted into Y(i,j). When the difference is less than a critical value T1, the local area is regarded as an uninteresting area. A value “o” is inputted into Y(i,j). In the present invention, although the critical value T1 is set as “4,” other proper values can be used within a scope of the present invention.

After the overall image is binary-coded, the binary-coded image is projected in a longitudinal direction and the interesting area is separated in a vertical direction from the image data projected in the longitudinal direction (S603 and S604).

In the process for projecting the binary-coded image in the longitudinal direction, the result value projected in the longitudinal direction as the mₜₕ line is stored in Vert(m), it can be expressed by the following equation 2.

$$Vert [ m ] = {\sum }_{n = 0}^{175} Y ( n , m ) , ( m = 0 , … 143 ) \qquad ( Equation 2 )$$

When a value obtained by subtracting 20 pixels from the Vert[m] value is less than 20-pixel, it is set as “0.” When Vert[m−1] is identical to Vert[m+1], it is set as “0” only when a value that is not “0” in the longitudinal direction is above 2-pixel. When the interesting area is separated as described above, sum total and mean values of the widths in the vertical direction of the interesting area (S605).

In the process for separating the interesting area in the vertical direction, blanks are found and used as a boundary between the divided areas while scanning the values projected in the vertical direction. That is, when it is assumed that starting and ending points of the interesting area in the vertical direction are stored in ROI[m] in order, it can be described as follows.

First, the values 0-143 stored in Vert[m] are scanned in order. When an area having the Vert[m] value that is not “0” are recognized as the interesting area and a case where the Vert[m] value is not “0” starts, the location values m are consecutively mapped in odd number locations from Roi[I]. When the case where the Vert[m] is not “0” ends, the location values m are consecutively mapped in the odd number location from Roi[1]. Then, the size of the interesting area is determined according to the sum total and mean values of the widths in the vertical direction (S606).

In the process for calculating the sum total and mean values of the widths in the vertical direction, the sum total value is first calculated by adding widths of the area divided by boarders and the mean value is calculated by dividing the sum total value by the number of the areas. That is, the sum total value ROI_{—SUM} and the mean value ROI_Mean can be expressed by the following equations 3 and 4.

$$\begin{matrix}{ROI}_{SUM} = {\sum }_{n = 0}^{{ROI}_{Number}} ( ROI [ 2 * n + 1 ] - ROI [ 2 * N ] ) & ( Equation 3 ) \\ ROI\_Mean = {ROI}_{sum} / {ROI}_{number} & ( Equation 4 )\end{matrix}$$

In the process for determining the size of the interesting area according to the sum total and mean values of the widths in the vertical direction, the critical value by which the interesting area is divided into large and small areas is compared with the sum total value in the vertical direction.

In the equations 3 and 4, the ROI_{—SUM} is a value used for the focus detecting unit and the ROI_Mean is a value used for the twist detecting unit. This will be described in more detail later.

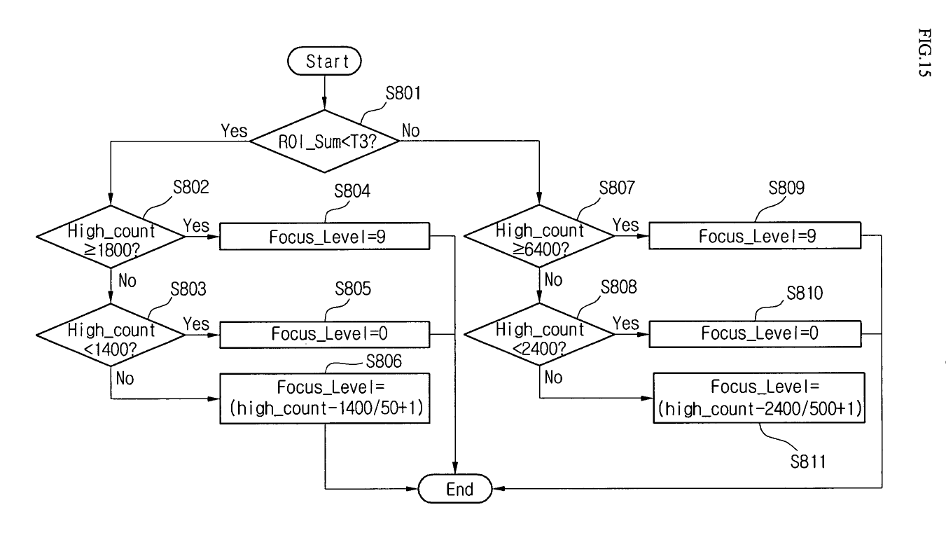

FIG. 14 is a flowchart illustrating an image detecting process of a focus detecting unit according to an embodiment of the present invention.

The detecting unit extracts high frequency components from the image inputted from the image capturing unit (S701). Noise is eliminated from the high frequency components by filtering the high frequency component, thereby providing a pure high frequency component (S702). When the high frequency components are extracted from the inputted image, a bright component is extracted in advance from the inputted image and then the high frequency component is extracted.

In order to eliminated the noise, a critical value is preset. Some of the components, which are higher than the critical value, are determined as the noise. Some of the components, which are lower than the critical value, are determined as the pure high frequency components.

A method for extracting the high frequency components is based on the following determinants 5 and 6. The determinant 5 is a mask determinant and the determinant 6 represents the local image brightness value.
h1 h2 h3 h4 h5 h6 h7 h8 h9 (Determinant 5)
Y(0.0) Y(0.1) Y(0.2) Y(1.0) Y(1.1) Y(1.2) Y(2.0) Y(2.1) Y(2.2) (Determinant 6)

The high frequency components can be obtained by the following equation 5 based on the determinants 5 and 6.
high=h1×Y(0,0)+h2×Y(0,1)+h3×Y(0.2)+h4×Y(1,0)+h5×Y(1,1)+h6×Y(1,2)+h7×Y(2,0)+h8×Y(2,0)+h8×Y(2,1)+h9×Y(2,2) (Equation 5)

In the process for obtaining the pure high frequency components without the noise, when it is assumed that the critical value is T2 and the number of pixel of a value that is determined as the high frequency component with respect to the total number of pixels of the inputted image is high_count, the pure high frequency components are obtained according to the following description.

When the high absolute value calculated by the equation 5 is |high| and the condition |high|<T2 is satisfied at each pixel location while scanning the overall area of the inputted image, the high_count that is the number of pixel is increased by 1. In the present invention, the critical value T2 is set as 40. However, the critical value T2 may vary according to the type of the image.

In the process for calculating the focusing level value from the high frequency components according to the size of the interesting area, an critical value T3 by which the size of the interesting areas is classified into large and small cases. In addition, according to the number of the focusing level values, the focusing level value is calculating by allowing the high frequency component value to correspond to the focusing level value. That is, when the critical value is T3 and the focusing level is Focus_level, it can be expressed by FIG. 15 according to the total sum value ROIsum calculated by the equation 3. In the present invention, the number of the focusing levels is set as 10 and the critical value T3 is set as 25. However, the number of the focusing levels and thee critical value T3 can vary according to the type of the image.

As described above, when the size of the interesting area is obtained by extracting the interesting area (S703) and the focusing level value is calculated from the high frequency components according to the size of the interesting area and displayed on the pre-view screen (S704), it becomes possible for the user to accurately adjust the focus.

That is, the focusing level value is calculated from the total sum value of the widths in the vertical direction.

FIG. 15 illustrates a focusing level detecting process of a focus detecting unit according to an embodiment of the present invention.

As shown in FIG. 15, when the critical value is T3, it is first determined if the ROI_Sum is less than 3 (S801). When the ROI_Sum is less than 3, it is determined if the HIGH_count is greater than or equal to 1800 (S802). When the HIGH_count is greater than or equal to 1800, the focusing level is adjusted to 9 (S804). When the HIGH_count is not greater than or equal to 1800, it is determined if the HIGH_count is less than 1400 (S803). When the HIGH_count is less than 1400, the focusing level is adjusted to 0 (S805). When the HIGH_count is not less than 1400, the focus level is adjusted according to (HIGH_count-1400)/50+1 (S806). In addition, when the ROI_sum is greater than or equal to 3 (S801), it is determined if the HIGH_count is greater than or equal to 6400 (S807). When the HIGH_count is greater than or equal to 6400, the focusing level is adjusted to 9 (S809). When the HIGH_count is not greater than or equal to 6400, it is determined if the HIGH_count is less than 2400 (S808). When the HIGH_count is less than 2400, the focusing level is adjusted to 0 (S810). When the HIGH_count is not less than 2400, the focus level is adjusted according to (HIGH_count-2400)/500+1 (S811).

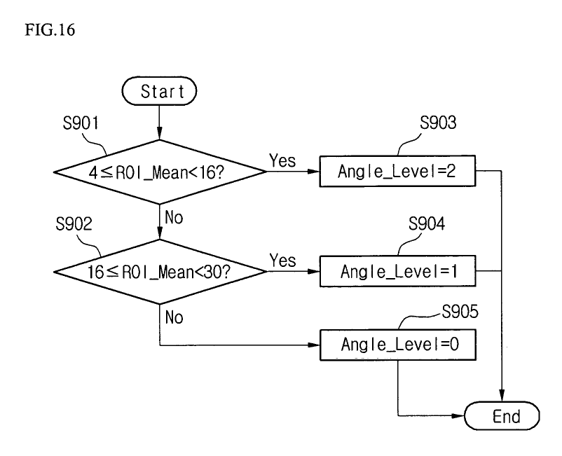

FIG. 16 illustrates a twist detecting process of a twist detecting unit according to an embodiment of the present invention.

A angle level value (angle_level) is first calculated from the ROI_Mean with reference to the equation 4. It is determined that the ROI_Mean is greater than or equal to 4 and less than 16 (S901). When the ROI_mean is greater than or equal to 4 and less than 16, the twist angle value is set as 2 (S903). When the ROI_Mean is not greater than or equal to 4 and less than 16, it is determined if the ROI_mean is greater than or equal to 16 and less than 30 (S902). When the ROI_mean is greater than or equal to 16 and less than 30, the twist angle value is set as 1 (S904). When the ROI_mean is not greater than or equal to 16 and less than 30, the twist angle value is set as 0 (S905). That is, the mean value of the widths in the vertical direction according to the number of twist levels is the twist level value.

According to the present invention, since the focusing and twisting states of the photographed image is displayed on the pre-view screen, the user can adjust the focus and twist state to take the clearer photographing image.

Therefore, even when no focusing control unit is provided to the camera, the clearer image can be obtained by calculating the focusing and twisting level values, thereby making it possible to accurately recognize the characters written on the photographed image.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A document image processing apparatus, comprising:
an image capturing unit for capturing an image of a document;
a detecting unit for detecting focusing and twisting states of the capture image;
a display unit for displaying the detected focusing and twisting states;
a character recognition unit for recognizing characters written on the capture image; and
a storing unit for storing the recognized characters by fields.

2. A document image processing apparatus according to claim 1, wherein the focusing and twisting states are displayed on a pre-view screen so as to let a user adjust the focusing and twist of the image.

3. The document image processing apparatus according to claim 1, wherein the storing unit is a personal information-managing database.

4. The document image processing apparatus according to claim 1, wherein the focusing and twist states are displayed in a numerical value or in a graphic image displaying a level.

5. A mobile phone with a name card recognition function, comprising:
a detecting unit for detecting focusing and twisting states of a name card image captured by a camera;
a display unit for displaying the focusing and twisting states of the name card image;
a character recognition unit for recognizing characters written on the name card image; and
a storing unit for storing the recognized characters in a personal information-managing database by fields.

6. The mobile phone according to claim 5, wherein the focusing and twisting states of the name card is detected by extracting an interesting area from the name card image, calculating a twisting level from a bright component obtained from the interesting area, and calculating a focusing level by extracting a high frequency component from the bright component.

7. A document image processing method of a mobile phone, comprising:
capturing an image of a document using a camera;
detecting focusing and/or twisting states of the captured image;
displaying the detected focusing and twisting states; and
guiding a user to finally capture the document image based on the displayed focusing and/or twist states.

8. A name card image processing method of a mobile phone, comprising:
capturing a name card image;
detecting focusing and/or twisting states of the captured name card image;
displaying the detected focusing and twisting states;
guiding a user to finally capture the document image based on the displayed focusing and/or twist states;
recognizing characters written on the captured image; and
storing the recognized characters by fields.

9. The name card image processing method according to claim 8, wherein the detecting the focusing and/or twisting states comprises:
extracting interesting areas from the name card image;
calculating a twisting level from a bright component obtained from the interesting area; and
calculating a focusing level by extracting a high frequency component from the bright component.

10. The name card image processing method according to claim 9, wherein the extracting the interesting area comprises:
obtaining histogram information from the bright component according to a local area;
binary-coding the name card image from the histogram information;
separating the interesting areas in the vertical direction from a binary-coded image data projected in a longitudinal direction;
calculating total sum and mean values of widths of the interesting area; and
determining a size of the interesting areas according to the total sum and mean values.

11. The name card image processing method according to claim 10, wherein the histogram information is obtained by setting a local area as a pixel-unit block.

12. The name card image processing method according to claim 10, wherein the binary-coding the histogram information is performed by binary-coding interesting and uninteresting areas with “1” or “0,” the interesting and uninteresting areas being determined based on a difference between maximum and minimum values of a histogram.

13. The name card image processing method according to claim 10, wherein the binary-coded image is projected in a longitudinal direction is performed by setting widths of the longitudinal and vertical directions as a pixel-unit block.

14. The name card image processing method according to claim 10, wherein the interesting areas in the vertical direction is divided by a space found by scanning the values projected in the vertical direction.

15. The name card image processing method according to claim 10, wherein the total sum value is obtained by adding all of the widths of the divided areas and the mean value is obtained by dividing the total sum value by the number of the areas.

16. The name card image processing method according to claim 10, wherein the size of the interesting areas is determined by comparing a predetermined critical value, that is preset by a user to determine a large or small case of the interesting areas, with the total sum value of the widths in the vertical direction.

17. The name card image processing method according to claim 9, wherein the twist level is calculated from the mean value of the widths in the vertical direction of the name card image.

18. The name card image processing method according to claim 17, wherein the twist level is a mean value of widths in the vertical direction.

19. The name card image processing method according to claim 9, wherein the calculating the focusing level comprises:
obtaining a high frequency component from the name card image; and
calculating the focusing level value from the high frequency value according to a size of the interesting areas.

20. The name card image processing method according to claim 19, further comprising obtaining a bright component of the name card image before obtaining the high frequency component of the name card image.
